(19) United States
(12) Patent Application Publication
(10) Pub. No.: US 2026/0038847 A1
(43) Pub. Date: Feb. 5, 2026

(54) METHOD FOR RECYCLING AQUEOUS POSOLYTE OF A REDOX FLOW BATTERY

(71) Applicant: KEMIWATT, RENNES (FR)

(72) Inventors: Mathilde CAZOT, LYON (FR); Thibault GODET-BAR, THORIGNE-FOUILLARD (FR); Solène GUIHENEUF, NOYAL SUR VILAINE (FR); Victor ABERKANE, CHARTRES DE BRETAGNE (FR)

(21) Appl. No.: 19/101,330

(22) PCT Filed: Aug. 7, 2023
(86) PCT No.: PCT/EP2023/071827

§ 371 Date: Feb. 5, 2025

(30) Foreign Application Priority Data
Aug. 8, 2022 (FR) FR2208171

(51) Int. Cl. H01M 8/008; H01M 8/18

(52) U.S. Cl. CPC H01M 8/008; H01M 8/18

(57) ABSTRACT

The present invention relates to a method for recycling an aqueous posolyte of a redox flow battery to be recycled, the aqueous posolyte comprising at least one electroactive compound and an aqueous solvent, the electroactive compound comprising at least an oxidized or reduced form of a redox couple, the reduced form of the redox couple being a water-soluble organometallic complex, characterised in that it comprises:
a step to precipitate (300) the electroactive compound, whereby a suspension is obtained,
a step to separate (400) the suspension, whereby a solid residue (52) and an effluent (54) are obtained, and
a step to dry (600) the solid residue (52), comprising heating the solid residue (52) to a temperature lower than or equal to 40° C., preferably lower than or equal to 35° C., more preferably lower than or equal to 30° C., further preferably lower than or equal to 25° C., whereby a recycled electroactive compound is obtained.

The present disclosure relates to a method for recycling an aqueous posolyte of a redox flow battery.

### PRIOR ART

A Redox Flow Battery is a system using liquids (called electrolytes) to store energy. Redox flow batteries store electricity and generate electricity via oxidation-reduction (redox) reaction. They generally have two compartments separated by an ion exchange membrane, in which current collectors (electrodes) are generally immersed.

One of the problems with current battery storage technologies is generally their use of ores and metals having a huge impact on the environment. In addition, the complex design and use of composite materials prevents easy, economical, and efficient recycling of critical materials. Although they claim to solve the environmental impact of energy production via the storing of renewable energy (and hence a reduction in CO₂ emissions per kWh of electricity produced), the lifecycle assessment of these technologies indicates very moderate sustainability. They generate resource depletion and much pollution owing to the waste represented by end-of-life batteries.

For existing technologies, recycling methods have been published in the literature, for example:
Li-ion battery (EP1269554B1): method for recycling and separating critical materials. Said method is complex and costly to implement.
Lead-acid battery (CA2986001A1): closed loop electrochemical process to recover lead for reuse;
Vanadium redox flow battery: recycling methods have already been proposed by mixing the two electrolytes, to be operated continuously during cycling to counter cross-over of vanadium ions through the membrane (Zhang, Y., Liu, L., Xi, J., Wu, Z., & Qiu, X. (2017). The benefits and limitations of electrolyte mixing in vanadium flow batteries. Applied Energy, 204, 373-381).
Zn-Br redox flow battery: bromine neutralization recovery process (CN103236570B).

At the current time, there are no recycling solutions for redox flow batteries using redox couples based on organic or organometallic compounds, in particular organic compounds, solubilised in an aqueous medium.

KEMIWATT employs organic and organometallic electrolytes dissolved in an aqueous medium to limit the impact of this technology on the environment and depletion of resources (use of critical metals/rare earths). Yet, to date, there does not exist any solution for the recycling of such batteries.

### Objectives of the Invention

The present invention sets out to solve the technical problem of providing a method for recycling redox flow batteries which use redox couples based on organic and/or organometallic compounds in an aqueous solution.

One particular objective of the present invention is to sole the technical problem of providing a method for recycling an aqueous posolyte for redox flow batteries.

One particular objective of the present invention is to solve the technical problem of providing an easy method for processing aqueous posolytes of spent redox low batteries and to isolate the electroactive compound(s), purify the latter and in particular make use thereof as raw material for new posolytes.

In particular, the present invention sets out to solve the aforementioned technical problems by limiting the impact on the environment and depletion of natural resources, or by limiting the quantity of organic and/or organometallic compounds used in electrolytes, in particular in the posolyte. Finally, the present invention sets out to solve the technical problem of reducing the production costs of redox flow batteries.

### DETAILED DESCRIPTION OF THE INVENTION

The present invention allows the solving of one and preferably all the technical problems raised herein.

To reinforce the eco-compatibility and economic competitivity of redox flow batteries using aqueous electrolytes comprising organic and/or organometallic compounds, the inventors have discovered and developed a method and system for recycling the electroactive compounds of the posolyte, in particular for reuse thereof in new redox flow batteries and thereby set up a circular economy around said redox flow batteries.

Advantageously, recycling according to the present invention comprises isolating of the electroactive compound(s) contained in the posolyte of spent batteries for subsequent upcycling thereof either directly for use in another application, or preferably by reintroducing the same in new redox flow batteries in the form of a fresh posolyte. Redox flow batteries can advantageously be recycled once they have lost at least 20% of their initial capacity.

Therefore, with the present invention it is possible to limit the quantity of newly introduced material for the production of redox flow batteries and/or to limit the consumption of natural or synthetic raw materials.

The present invention therefore concerns a method for recycling an aqueous posolyte of a redox flow battery to be recycled, the aqueous posolyte comprising at least one electroactive compound and an aqueous solvent, the electroactive compound comprising at least an oxidized or reduced form of a redox couple, the reduced form of the redox couple being a water-soluble organometallic complex, characterized in that it comprises:
a precipitation step of the electroactive compound, whereby a suspension is obtained;
a separation step of the suspension, whereby a solid residue and an effluent are obtained; and
a drying step of the solid residue, comprising heating of the solid residue to a temperature lower than or equal to 40° C., preferably lower than or equal to 35° C., more preferably lower than or equal to 30° C., further preferably lower than or equal to 25° C., whereby a recycled electroactive compound is obtained.

By electroactive compound, it is meant an organic or organometallic compound belonging to a redox couple, and indifferently designates either the oxidant (oxidized form) of the redox couple, or the reductant (reduced form) of the redox couple, or the mixture of the oxidant and reductant of the redox couple.

By aqueous electrolyte, it is meant aqueous solutions comprising the electric compound(s) and placed in the positive and negative compartments of a redox flow battery.

By posolyte, it is designated the electrolyte in the positive compartment of a redox flow battery, and by negolyte the electrolyte in the negative compartment of a redox flow battery.

By water-soluble organometallic complex, it is meant an organometallic complex having solubility in water at 25° C. higher than or equal to 0.1 mol/L, preferably higher than or equal to 0.3 mol/L, advantageously higher than or equal to 0.5 mol/L i.e. this means that an aqueous solution comprising at least 0.1 mol/L, preferably at least 0.3 mol/L, advantageously at least 0.5 mol/L of this complex does not exhibit a precipitate or insoluble parts at 25° C.

Preferably, the metal of the organometallic complex is chosen from among iron or copper. Preferably, the metal of the organometallic complex, in its reduced form, has an oxidation number between 0 and 2, preferably of 0 if the metal is copper, or 2 if the metal is iron. More preferably, the reduced form of the redox couple is an iron organometallic complex having an oxidation number in its reduced form of 2, and preferably chosen from among ferrocene and the ferrocyanide ion, advantageously the ferrocyanide ion.

Preferably, the method successively comprises:
a collecting step of an aqueous posolyte of a redox flow battery comprising at least one electroactive compound;
a precipitation step of the electroactive compound, whereby a suspension is obtained;
a separation step of the suspension, whereby a solid residue and an effluent are obtained; and
optionally a water rinsing and water trituration step of the solid residue obtained after the separation step, followed by a second separation step, whereby a rinsed solid residue is obtained, and
a drying step of the solid residue or rinsed solid residue to obtain a dried solid residue.

The steps of the method can be implemented using any technique known to those skilled in the art.

The collecting step is preferably carried out by pumping the posolyte from the redox flow battery to be recycled towards a container, preferably directly at the site of use of the battery. In one embodiment, the collecting step additionally comprises a step to transfer the electrolyte(s) from the container towards a reactor.

The collecting step is preferably performed after a step to fully discharge the redox flow battery. In other words, the posolyte collected at the collecting step is preferably a posolyte of which the electroactive compound is in its reduced form.

The aqueous posolyte collected from the redox flow battery is a spent aqueous posolyte since it has undergone at least one charging and/or discharging cycle. Preferably, the spent aqueous posolyte is collected at the end of the cycle lifetime of the battery.

The separation step is preferably performed via filtration e.g. using a decanter centrifuge.

The solid residue obtained after the separation step comprises the precipitated electroactive compound(s).

The rinsing and trituration step with water allows an improvement in the purity of the solid residue, and in particular allows removal of the precipitating agent used if it is scarcely volatile. However, it increases the quantity of effluent to be treated.

The method of the invention is preferably devoid of a rinsing step of the solid residue.

The drying step can be performed by heating the solid residue and/or placing this residue under reduced pressure.

It has surprisingly been found that the drying temperature of the solid residue has a major impact on the electrochemical properties of the recycled electroactive compound obtained after the recycling method: a drying temperature of the solid residue higher than 40° C. leads to a significant drop in the performance of a battery with a recycled posolyte comprising said recycled electroactive compound.

Preferably, the drying step of the solid residue comprises heating the solid residue to a temperature of between 15° C. and 35° C., more preferably between 20° C. and 30° C., advantageously between 23° C. and 27° C.

To improve the drying step, it is also advantageous to use reduced pressure. Preferably, the drying step is performed at an absolute pressure lower than or equal to 1 bar, more preferably lower than or equal to 0.8 bar, advantageously lower than 0.5 bar.

Preferably, the precipitation step comprises the addition of an anti-solvent of the electroactive compound and/or the addition of an acid or base, and/or the addition of a salt to the aqueous posolyte.

Preferably, the adding step of an anti-solvent is carried out in a reactor vessel under agitation.

By anti-solvent, it is meant an organic solvent in which the electroactive compound is less soluble than in water.

Preferably, the anti-solvent is chosen for the ability thereof to lower the solubility of the electroactive compound in the initial aqueous medium, and is preferably chosen from among solvents in which the electroactive compound is 5 times less soluble than in water, more preferably 10 times less soluble, advantageously 100 times less soluble. In other words, the ratio between the solubility of the electroactive compound in water and the solubility of the electroactive compound in the anti-solvent is preferably higher than or equal to 5, more preferably higher than or equal to 10, advantageously higher than or equal to 100. The solubility of the electroactive compound in water or anti-solvent is the maximum concentration, in g/mol at 25° C., at which the electroactive compound is able to dissolve in water or the anti-solvent respectively, forming a homogenous mixture i.e. without the formation of a precipitate.

Preferably, the anti-solvent is chosen from among water-miscible aprotic and protic polar solvents comprising an alcohol function, nitrile function or ketone function.

Preferably, the anti-solvent is an organic solvent, preferably chosen from the group of water-miscible aprotic and protic polar solvents, more preferably chosen from among alcohols, preferably aliphatic alcohols, advantageously saturated aliphatic alcohols such as methanol, ethanol, or 1-propanol and iso-propanol, and organic solvents comprising a nitrile function such as acetonitrile, or a ketone function such as acetone, or any of the mixtures thereof. The use of a mixture of at least two anti-solvents increases the amount of precipitated electroactive compound.

Preferably, the acid is a strong acid or a weak acid. The strong acid can be chosen from the group formed by sulfuric acid, hydrochloric acid, nitric acid, hydroiodic acid, hydrobromic acid, perchloric acid, permanganic acid, manganic acid, chloric acid, phosphoric acid or any of the mixtures thereof. The weak acid may comprise at least one carboxylic acid function such as formic acid, acetic acid, benzoic acid, citric acid, lactic acid, oxalic acid or maleic acid. Preferably, the acid is a strong acid. The use of a strong acid allows an increase in the amount of precipitated electroactive compound. More preferably, the acid is sulfuric acid or acetic acid, advantageously sulfuric acid.

Preferably, the quantity of acid added to the aqueous posolyte corresponds to the quantity of acid needed to obtain a pH lower than or equal to 10, preferably lower than or equal to 8, more preferably lower than or equal to 7 and further preferably lower than or equal to 6. Still further preferably, the quantity of acid added to the aqueous posolyte corresponds to the quantity of acid needed to obtain a pH lower than or equal to 10 and higher than or equal to 1, more preferably lower than or equal to 8 and higher than or equal to 2, further preferably lower than or equal to 6 and higher than or equal to 3.

Preferably, the acid is added under agitation.

Preferably, the base is an inorganic base. The base can be chosen from the group formed by alkaline hydroxides such as NaOH or KOH, and alkaline carbonates such as Na₂CO₃ or K₂CO₃.

Preferably, the quantity of base added to the aqueous posolyte corresponds to the quantity of base needed to obtain a pH higher than or equal to 7, preferably higher than or equal to 8, more preferably higher than or equal to 10. Further preferably, the quantity of base added to the aqueous posolyte corresponds to the quantity of base needed to obtain a pH lower than or equal to 14 and higher than or equal to 7, more preferably lower than or equal to 13 and higher than or equal 10.

Preferably, the salt is an inorganic salt, preferably KCl or NaCl, or an organic salt preferably sodium acetate or ammonium carbonate.

Preferably, the inorganic salt is chosen from among inorganic salts having a cation corresponding to the cation or to one of the cations contained in the aqueous posolyte to be recycled.

The addition of an anti-solvent of the electroactive compound, the addition of an acid or base and the addition of a salt to the aqueous posolyte can be combined two-by-two or can all be added together to optimize precipitation of the electroactive compound, as a function of the solubility thereof.

Preferably, the precipitation step comprises the addition to the aqueous posolyte of an anti-solvent of the electroactive compound, preferably an anti-solvent of the reductant of the redox couple contained in the posolyte. The anti-solvent is as defined above.

Preferably, the volume of added anti-solvent representing between 1% and 70% of the volume of aqueous posolyte to be processed, preferably between 20% and 40%, more preferably between 25% and 35%. Preferably the concentration of electroactive compound is higher than or equal to 0.1 M, preferably higher than or equal 0.2 M, preferably between 0.1 M and 10 M. Preferably, the concentration of organometallic complex is higher than or equal to 0.1 M, preferably higher than or equal to 0.2M, preferably between 0.1 M and 10 M.

Preferably, the anti-solvent added to the aqueous posolyte is at a temperature of between 0° C. and 15° C.

Preferably, the method of the invention comprises a chemical reduction step before the precipitation step, comprising the contacting of the posolyte with a reductant able to reduce the oxidized form of the redox couple. Preferably, the chemical reduction step is between the collecting step and the precipitation step.

This step is preferably performed when the posolyte has been collected from a redox flow battery that has not been full discharged before the collecting step.

Therefore, preferably, the electroactive molecule to be precipitated is the reductant of the redox couple contained in the posolyte.

By reductant able to reduce the oxidant of the redox couple, it is meant any compound belonging to a redox couple differing from the redox couple contained in the posolyte and having a standard redox potential strictly lower than the standard redox potential of the redox couple contained in the posolyte.

Preferably, the contacting step of the posolyte with a reductant able to reduce the oxidant of the redox couple comprises the adding of a reductant to the aqueous electrolyte. Preferably, the addition of a reductant to the aqueous electrolyte is performed while monitoring pH which must preferably remain higher than or equal to 8.

Preferably, the reductant is chosen from the group formed by H₂O₂, Na₂SO₃, Na₂S₂O₄, Na₂S₂O₃, N₂H₄ (hydrazine), I₂ (iodine), and organic reducing agents such as ascorbic acid, citric acid, and the derivatives of glucose.

Preferably, at the precipitation step, the aqueous electrolyte is at a temperature of between 5° C. and 40° C., preferably between 10° C. and 35° C., and advantageously between 15° C. and 30° C.

In one embodiment, the method of the invention additionally comprises a formulation step of the recycled solid residue, comprising the dissolution of the recycled solid residue in an aqueous medium to obtain a recycled posolyte.

This formulation step may further comprise the addition of other constituents to the recycled posolyte e.g. additives.

The choice of other constituents is dependent on the desired performances of the recycled posolyte.

The method of the invention may additionally comprise a step to input the recycled posolyte obtained after the formulation step (700) into the positive compartment of a redox flow battery.

In one variant, the method of the invention additionally comprises a step to treat the effluent obtained after the separation step, to obtain a treated effluent. The treated effluent can be reused at the precipitation step.

The method of the invention may additionally comprise a step to verify the purity of the solid residue, for example by chemical and/or electrochemical analysis.

In one embodiment of the method of the invention, the aqueous posolyte to be recycled may comprise at least one additive. In this embodiment, depending on the solubility of the additive, the additive is either recycled with the electroactive compound and in this case is included in the solid residue, or it is included in the effluent obtained on completion of the method.

By additive, it is meant any compound able to increase some physicochemical properties of the posolyte.

The invention also concerns a system for recycling an aqueous posolyte of a redox flow battery, comprising:
a collecting device of an aqueous posolyte from a redox flow battery, the aqueous posolyte comprising at least one electroactive compound and an aqueous solvent,
a precipitation device of the electroactive compound via the addition of an anti-solvent of the electroactive compound and/or addition of an acid or base and/or addition of a salt, to provide a suspension comprising a solid residue and an effluent, and
a drying device to allow drying of the solid residue at a temperature lower than or equal to 40° C., preferably lower than or equal to 35° C., more preferably lower than or equal to 30° C., further preferably lower than or equal to 25° C.

The collecting device preferably comprises a collector vessel for the collected aqueous posolyte and a device capable of transferring the posolyte from the redox flow battery towards the collector vessel. The collector vessel is in fluid communication for example with the positive compartment of the redox flow battery to be recycled. The aqueous posolyte collected from the redox flow battery is a spent aqueous posolyte since it has undergone at least one charge and/or discharge cycle. Preferably, the spent aqueous posolyte is collected at the end of the cycle lifetime of the battery.

The system of the invention may additionally comprise a first storage vessel comprising an anti-solvent of the electroactive compound of the collected aqueous posolyte, and/or comprising an acid or base solution and/or a salt solution such as defined in the description of the method of the invention, more preferably a vessel to store an anti-solvent of the electroactive compound of the collected aqueous posolyte. The first storage vessel is in fluid communication with the precipitation device.

In one embodiment, the recycling system of the invention comprises a discharging device able to reduce the oxidant of the redox couple in the posolyte. The discharging device is preferably in fluid communication with a second storage vessel comprising a reductant able to reduce the oxidant of the redox couple such as defined above. The discharging device is preferably in fluid communication with the collector vessel and precipitation device.

Preferably, the recycling system of the invention additionally comprises a separation device to separate the suspension derived from the precipitation device into a solid residue and an effluent. For example, the separation device can be a decanter centrifuge.

The solid residue obtained in the separation device comprises the precipitated electroactive compound(s).

The separation device is preferably in fluid communication with the precipitation device and the drying or formulation device.

In one embodiment of the invention, the separation device is able to dry the optionally rinsed solid residue, partially or fully. In this embodiment, the drying device is included in the separation device.

Alternatively, the system of the invention comprises a separate device for drying the solid residue by heating and/or by placing the optionally rinsed solid residue under reduced pressure.

In one embodiment, the system of the invention additionally comprises a device to treat the effluent derived from the separation device, to obtain a treated effluent. The treatment device is in fluid communication with the storage vessel and/or with the precipitation device.

Preferably, the recycling system of the invention additionally comprises a formulation device to formulate the solid residue in the form of a recycled posolyte.

The system of the invention may additionally comprise a formulation vessel comprising an aqueous solution optionally comprising one or more additives such as defined above. The formulation vessel is in fluid communication with the formulation device.

On leaving the formulation device, the recycled posolyte can be introduce into the positive compartment of a new redox flow battery, preferably via a fluid connection.

Preferably, the recycling system of the invention is used to implement the method of the invention.

### Advantage of the Invention

It is particularly surprising that said electroactive compounds are able to be recycled by precipitation. The recycling method of the invention is particularly easy to implement and hence particularly innovative. With this method, it is possible to obtain very good recycling yields of electroactive compounds.

Most surprisingly, the electroactive compounds recycled with the method of the invention can be reused for fresh cycling in a new redox flow battery, giving very satisfactory performance in particular in terms of capacity and/or ohmic resistance (<2 Ω·cm²) and with stability over repeated operating cycles of the redox battery, the battery remaining substantially stable over several ten or hundred cycles. Such performance is unexpected for those skilled in the art.

A further advantage of the method of the invention is that a small quantity of reagents is used (proportionally to treated volume). In addition, these reagents are easily available (and already used in numerous other applications), and also low-cost. For example, ethanol is not a threat for the environment.

Additionally, precipitation is rapid and the method of the invention does not generate any pollution of the recycled electroactive compounds: purification of the solid residue solely requires an evaporation step. Advantageously, the yield of the method of the invention, and the reduced cost thereof, allow industrialization of the method and system of the invention.

Unless specifically stated otherwise, the expressions «from X to Y» and «between X and Y» designate ranges of which the limits X and Y are included.

### FIGURES

FIG. 1 is a schematic block diagram of a method of the invention.

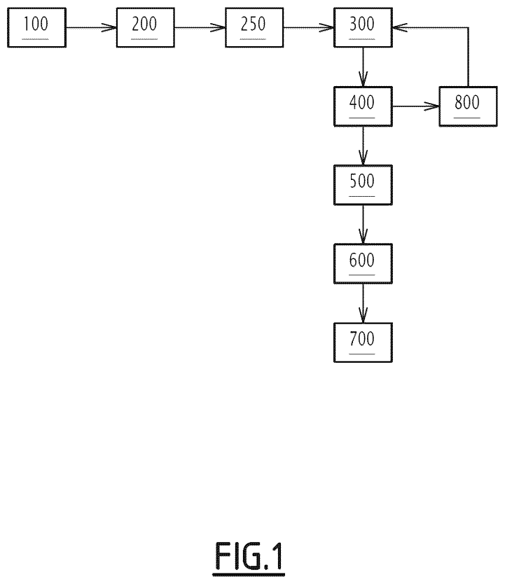

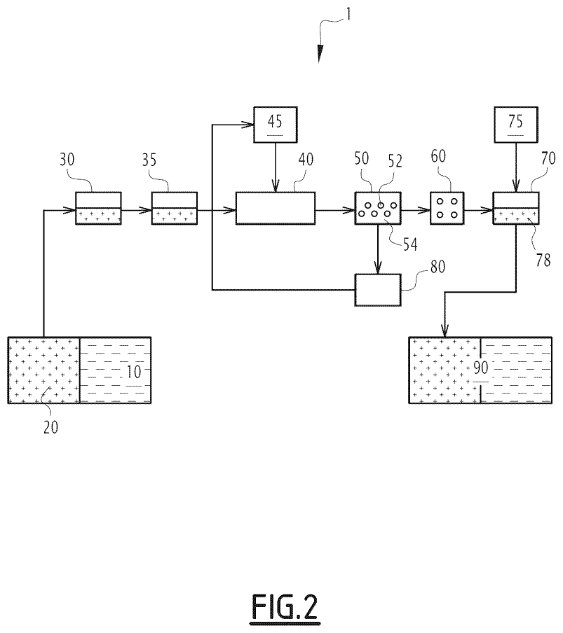

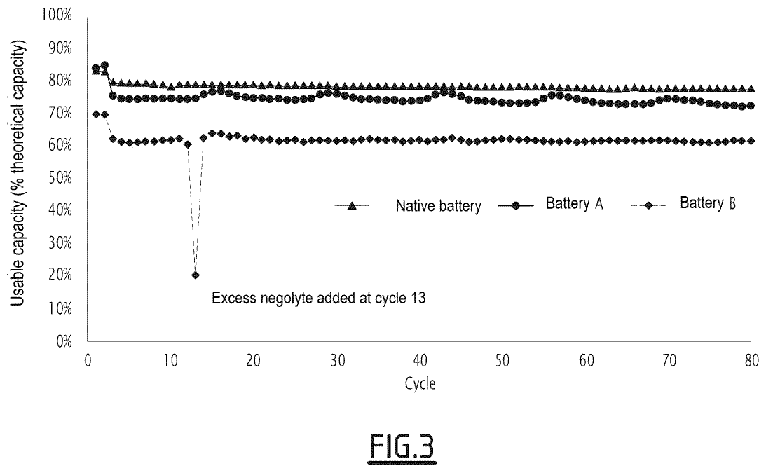

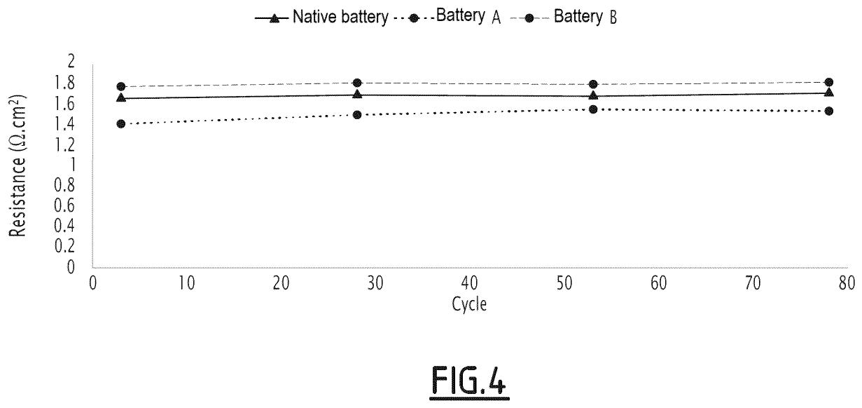

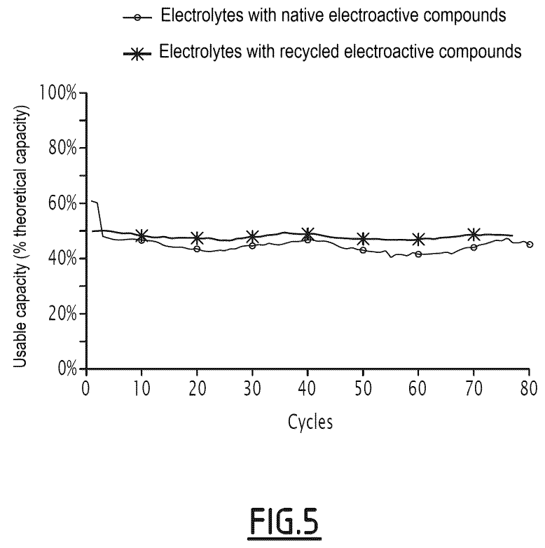

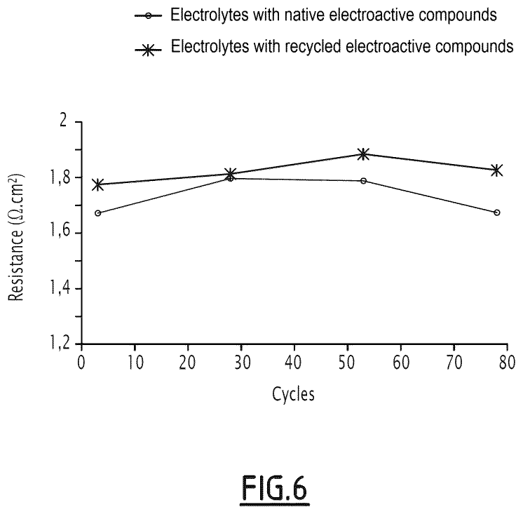

After the cycling 100 of a redox flow battery, an aqueous posolyte of the redox flow battery is collected at a collecting step 200. The electroactive compound(s) contained in the aqueous posolyte are optionally contacted with a reductant, to be discharged at a chemical reduction step (250). The electroactive compound(s) contained in the aqueous posolyte are precipitated at a precipitation step 300, preferably via the addition of an anti-solvent and/or the addition of an acid or base and/or the addition of a salt to the aqueous electrolyte of the electroactive compound in the aqueous posolyte. The suspension obtained after the precipitation step 300 is separated into a solid residue and an effluent at a separation step 400. A solid residue comprising the electroactive compound(s), and an effluent are obtained. The solid residue can be rinsed with water and triturated at a water rinsing and water trituration step 500. The solid residue, whether or not rinsed, is then dried at a drying step 600 to reduce the quantity of water and/or solvent in the solid residue. The drying temperature must not exceed 40° C. The recycled electroactive compound obtained after the drying step can be formulated at a formulation step 700, to obtain a recycled posolyte. The recycled posolyte can be used in a new redox flow battery alone or in a mixture with a posolyte comprising one or more native electroactive compounds i.e. which have never been used in a charge and/or discharge cycle of a redox flow battery. In parallel, the effluent obtained after the separation step can be treated at a treatment step 800, to obtain a treated effluent able to be reused at the precipitation step 300 when the method of the invention is next implemented.

FIG. 2 schematically illustrates a recycling system 1 of the invention of an aqueous posolyte in a redox flow battery 10.

A posolyte 20 of a redox flow battery 10 is collected in a collector vessel 30, optionally conveyed towards a discharging device 35 then conveyed towards a precipitation device 40. An acid or base and/or salt solution and/or an anti-solvent of the electroactive compound of the collected aqueous posolyte, fed from a storage vessel 45, is added to the posolyte 20 in the precipitation device 40 to cause precipitation of the electroactive compound(s) of the posolyte 20. The suspension obtained is separated, preferably via filtration, in a separation device 50. A solid residue 52 comprising the electroactive compound(s) of the posolyte 20 and an effluent 54 are obtained. The effluent 54 is received in an effluent collector device 80 and can be treated and redirected towards the storage vessel 45. Optionally, the solid residue 52 is rinsed with water and triturated with water, then separated a second time to remove the wash water. The residue 52 (whether or not rinsed) is dried or partially dried, either directly in the separation device, or after being transferred to a drying device 60. The drying device allows the residue 52 to be heated under controlled temperature and/or placed under reduced pressure, thereby reducing the amount of water and any solvents remaining in the solid residue 52. The resulting solid residue 52 is conveyed towards a formulation device 70. An aqueous solution optionally comprising additives is also sent into the formulation device 70 from a formulation vessel 75 to prepare a recycled posolyte 78. The recycled posolyte 78 can be fed into the positive compartment of a new redox flow battery 90.

FIG. 3 is a graph showing usable battery cycling capacity (TRL 4) (as a percentage of the theoretical capacity of the electrolytes) of a battery comprising electrolytes with native electroactive compound, and of two batteries A and B comprising a negolyte with native electroactive compound and a posolyte with recycled electroactive compound, the recycled electroactive compound having been dried under different conditions for batteries A and B.

FIG. 4 is a graph showing battery resistance (TRL 4) measured on a polarisation curve of a battery comprising electrolytes with native electroactive compound, and two batteries comprising a negolyte with native electroactive compound and a posolyte with recycled electroactive compound, the recycled electroactive compound having been dried under different conditions.

FIG. 5 is a graph showing usable battery cycling capacity (TRL 4) (as a percentage of the theoretical capacity of the electrolytes) of a battery comprising electrolytes with native electroactive compound, and a battery comprising electrolytes with recycled electroactive compound on the posolyte side and negolyte side.

FIG. 6 is a graph showing battery resistance (TRL 4) measured on a polarisation curve of a battery comprising electrolytes with native electroactive compound, and a battery comprising electrolytes with recycled electroactive compounds.

The present invention is now described with reference to nonlimiting examples.

### EXAMPLES

### Example 1: Recycling of a Posolyte Comprising the Ferrocyanide/Ferricyanide Redox Couple-Effect on Temperature on Drying

The recycling method was performed on a posolyte that had been used in a battery (>500 cycles and cycling time of 4 months).

At the end of the cycling time, the electroactive compound(s) of the ferrocyanide/ferricyanide redox couple in the posolyte were first chemically reduced e.g. though the addition of H₂O₂, while monitoring pH (which must preferably remain higher than 8) and under agitation, to obtain an electrolyte comprising 100% ferrocyanide. The concentration of electroactive compounds in the negolyte was 0.2 M and the concentration of electroactive compounds in the posolyte was 0.7 M.

Precipitation was then performed with the addition of a volume of 96% ethanol (in liquid form) to the electrolyte under magnetic stirring, the volume of ethanol corresponding to 30% of the volume of the posolyte; the quantity of ethanol must be controlled since the effect would be counter-productive if a certain volume is exceeded, and the ferrocyanide would re-dissolve in the solvent mixture.

The solution was afterwards filtered (e.g. on (5-10 μm) filter paper), and the solid residue obtained was dried of residual traces of solvent (water+ethanol) via evaporation at two temperatures: 20° C. and 45° C.

The type and quantity of solvent used in each case, and the yields and purities obtained are given in Table 1.

TABLE 1

| | A | B |
|---|---|---|
| Concentration of electroactive | 0.7M | 0.7M |
| compounds in the posolyte | | |
| Proportion of added solvent (% | 30% | 30% |
| total volume of the electrolyte to | 96% Ethanol | Ethanol à 96% |
| be recycled) and type of solvent | at 5° C. | à 5° C. |
| Drying temperature | Drying at | Drying at |
| | 20° C. | 45° C. |
| Recycling yield | 76% | 76% |
| Purity of the electroactive | 90% | 93% |
| compound after drying (UV | | |
| analysis of the powder) | | |

When heating the filtered powder on a hot plate at 45° C., the powder gradually releases moisture again forming a paste; it must then be refiltered to obtain a powder that is re-dried in open air without any particular heating.

UV analysis of the 2 samples gave satisfactory purities (higher than 90%) and an unchanged signature compared with the initial powder.

Each recycled electroactive compound A and B was re-solubilized in an aqueous medium to obtain two recycled posolytes A and B. Each posolyte was tested in a battery in association with a non-recycled negolyte comprising (M3CH) as electroactive compound:

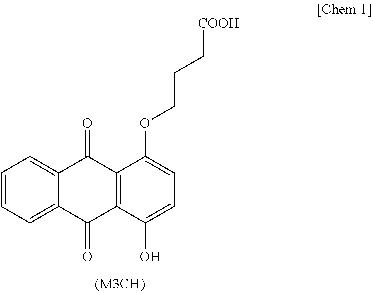 [SMILES: O=C(O)CCCOc1ccc(O)c2c1C(=O)c1ccccc1C2=O]

FIGS. 3 and 4 show the performance levels obtained with a «native» battery comprising electrolytes solely having native electroactive compounds (compound M3CH in the negolyte and ferrocyanide ion in the posolyte), and with two batteries A and B comprising the same negolyte but the recycled posolyte A or B respectively.

It can be observed that capacity (FIG. 3) and internal battery resistance (FIG. 4) are the same for the native battery and battery A (the difference which can be seen between the two curves lies within the error of reproducibility), but the performance of battery B which comprises the recycled posolyte obtained after heating ferrocyanide at 45° C. is significantly lower than that of the native battery and battery A in terms of usable capacity.

Excess negolyte was added at cycle 13 of battery B to verify that the limitation was indeed due to the posolyte.

It is therefore unexpectedly observed that the drying temperature of the recycled ferrocyanide has a deleterious effect on the redox properties thereof. This was fully unforeseeable insofar as no degradation was observed under UV characterization, this being the indicated characterization method for the ferrocyanide compound.

### Example 2: Recycling and Battery Test of the Redox Couple Ferrocyanide/Ferricyanide (Posolyte) and Anthraquinone (M3CH) (Negolyte)

The recycling method was performed on electrolytes that had been used in a battery (>350 cycles and cycling time of 6 months). The results give both the characteristics of the recycling method and the performance of batteries comprising the recycled electrolytes.

Regarding the negolyte, the electroactive molecule (M3CH) of the negolyte in reduced form is automatically discharged (i.e.oxidized) through the action of the dioxygen in air. Precipitation of the electroactive molecule was caused by acidification of the negolyte solution up to a pH value lower than or equal to 6. The method was tested with several types of acid (strong acid e.g. sulfuric acid, weak acid e.g. acetic acid), and led to equivalent results. The quantity of acid to be added is solely dependent on the volume of negolyte to be processed and the initial pH thereof. It is added under agitation. As soon as the pH value is lower than or equal to 6, precipitation is instantaneous. The effluent can be filtered on a filter with large pore size since the cake obtained is very compact forming a block. The precipitate must be rinsed with water to remove traces of acid and then spread out to facilitate the drying step and to remove residual traces of solvent.

The type and quantity of solvent used for each electrolyte, and the yields and purities obtained are given in Table 2. The necessary quantities of solvent were 10 and 30% by volume respectively for the negolyte and posolyte. This addition tends to decrease for the posolyte when the concentration of electroactive compound increases. Yields are higher than 65%, with an expected improvement under an optimized industrial process. The purity of the recycled electroactive compound obtained after simple drying was estimated by quantitative proton NMR (¹H-qNMR) in the presence of an internal standard. This purity was 92 and 93% respectively, proving the easy removal of the solvent used for precipitation. In comparison, the purity of these same native electroactive compounds is about 97% for anthraquinone and 96% for the ferrocyanide salt.

Quantitative NMR: ¹H NMR spectra were recorded on a BRUKER AC 300 P spectrometer (300 MHZ). Maleic acid (Acros Organics) was used as internal standard to evaluate the purity of the compounds.

TABLE 2

| Recycling of electroactive | | |
|---|---|---|
| compounds | Negolyte | Posolyte |
| Concentration of electroactive | 0.2M | 0.34M |
| compounds | | |
| Proportion of added solvent (% total | 10% | 30% |
| volume of electrolyte to be | (99% pure | (96% Ethanol) |
| recycled) and type of solvent | CH₃COOH) | |
| Recycling yield | 65% | 72% |
| Purity of electroactive compound | 92% | 93% |
| after drying (¹H-qNMR) | | |

FIGS. 5 and 6 give the performance levels obtained with a battery comprising electrolytes comprising native electroactive compound(s), and with a recycled battery i.e. comprising a negolyte and posolyte formulated from electroactive compound(s) recycled under the conditions of Table 2 above.

The usable capacity (FIG. 5) was the same for both batteries (the difference which can be seen between the two curves lies within the reproducibility error), which surprisingly proves that recycling via precipitation of the electroactive compounds has no impact on the electrochemical activity thereof. The trend in this capacity over cycling is stable.

Battery internal resistance (FIG. 6) was also equivalent for both batteries and remained constant over cycling. This result surprisingly confirms that the solvents used for precipitation have no impact on the performance of the system.

Comparison between the two battery tests highlights the fact that the active materials of an aqueous organic redox flow battery can be recycled by precipitation and reused in a new storage system without deterioration of performance.

1-10. (canceled)

11. A method for recycling an aqueous posolyte of a redox flow battery to be recycled, the aqueous posolyte comprising at least one electroactive compound and an aqueous solvent, the electroactive compound comprising at least an oxidized or reduced form of a redox couple, the reduced form of the redox couple being a water-soluble organometallic complex, the method comprising:
a precipitation step of the electroactive compound, whereby a suspension is obtained,
a separation step of the suspension, whereby a solid residue and an effluent are obtained, and
a drying step of the solid residue, comprising heating the solid residue to a temperature lower than or equal to 40° C., whereby a recycled electroactive compound is obtained.

12. The method according to claim 11, wherein the precipitation step comprises the addition of an anti-solvent of the electroactive compound and/or the addition of an acid or base and/or the addition of a salt to the aqueous posolyte.

13. The method according to claim 11, wherein the precipitation step comprises the addition of an anti-solvent of the electroactive compound to the aqueous posolyte.

14. The method according to claim 13, wherein the volume of added anti-solvent represents between 1% and 70% of the volume of the aqueous posolyte to be processed.

15. The method according to claim 14, wherein the concentration of organometallic complex is higher than or equal to 0.1 M.

16. The method according to claim 13, wherein the anti-solvent added to the aqueous posolyte is at a temperature of between 0° C. and 15° C.

17. The method according to claim 13, wherein the anti-solvent is chosen from among water-miscible aprotic and protic polar solvents comprising an alcohol function, nitrile function or ketone function.

18. The method according to claim 11, further comprising a chemical reduction step before the precipitation step, comprising the contacting of the posolyte with a reductant able to reduce the oxidized form of the redox couple.

19. The method according to claim 11, wherein the reduced form of the redox couple is an iron organometallic complex having an oxidation number of 2.

20. The method according to claim 11, further comprising a formulation step of the recycled electroactive compound, comprising the dissolution of the recycled electroactive compound in an aqueous medium to obtain a recycled posolyte.

21. The method according to claim 11, wherein the reduced form of the redox couple is selected from the list consisting in ferrocene and the ferrocyanide ion.

22. The method according to claim 11, wherein the reduced form of the redox couple is the ferrocyanide ion.
